(19) United States
(12) Patent Application Publication
(10) Pub. No.: US 2013/0061021 A1
(43) Pub. Date: Mar. 7, 2013

(54) SEMICONDUCTOR MEMORY SYSTEM AND METHOD FOR CONTROLLING SAME

(71) Applicants: Young Goan Kim, Seoul (KR); Hyung Min Kim, Seongnam Si (KR); Chi Sung An, Seongnam Si (KR)

(72) Inventors: Young Goan Kim, Seoul (KR); Hyung Min Kim, Seongnam Si (KR); Chi Sung An, Seongnam Si (KR)

(73) Assignee: NOVACHIPS CO., LTD., Seongnam-si, Gyeonggi-do (KR)

(21) Appl. No.: 13/517,301

(22) PCT Filed: May 12, 2011
(86) PCT No.: PCT/KR2011/003511

§ 371 Date: Jun. 20, 2012

(30) Foreign Application Priority Data
May 18, 2010 (KR) 10-2010-0046330

(51) Int. Cl. G06F 12/10

(52) U.S. Cl. 711/202; 711/E12.058

(57) ABSTRACT

Disclosed are a semiconductor memory system and a method for controlling same. The semiconductor memory system according to one embodiment of the present invention includes: a first memory for storing normal data and master metadata, the master metadata representing a relationship between a local address and a physical address for accessing the normal data; and a control logic generating compression metadata compressed in accordance with update metadata and storing the generated metadata in the first memory in response to a first control signal.

### TECHNICAL FIELD

The present invention relates to a semiconductor memory system and a control method for the same, and more particularly to a semiconductor memory system capable of efficiently managing metadata and a method for controlling metadata in the semiconductor memory system.

### BACKGROUND ART

A logical address of a flash memory device, which a file system has generated, is converted into a physical address by a Flash Translation Layer (FTL). Information required for this address conversion is called metadata, and it is necessary to efficiently manage the metadata.

### DETAILED DESCRIPTION OF THE INVENTION

### Technical Problem

Therefore, an aspect of the present invention is to provide a semiconductor memory system capable of efficiently managing metadata and a method for controlling metadata in the semiconductor memory system.

### Technical Solution

In accordance with an aspect of the present invention, there is provided a semiconductor memory system which includes: a first memory for storing normal data and master metadata representing a relation between a logical address and a physical address for accessing the normal data; and a control logic for generating compressed metadata compressed in accordance with updated metadata in response to a first control signal and storing the compressed metadata in the first memory.

The compressed metadata may be generated by compressing bitmap data representing a difference between the updated metadata and the master metadata. At this time, the bitmap data may be generated by performing exclusive-OR on the master metadata and the updated metadata.

The control logic may include a compressor for generating the compressed metadata.

The control logic may further include a reconstructor for reconstructing the updated metadata from the compressed metadata. At this time, the reconstructor may reconstruct the updated metadata by comparing bitmap data with the master metadata after decompressing the compressed metadata and reconstructing the bitmap data. In this case, the reconstructor may reconstruct the updated metadata by performing exclusive-OR on the master metadata and the bitmap data.

Then, the reconstructed updated metadata may be loaded into a second memory. In this case, the second memory may correspond to a cache memory.

The first memory may correspond to a flash memory.

In order to accomplish the above-mentioned objects, in accordance with an aspect of the present invention, there is provided a control method in a semiconductor memory system. The control method includes: storing compressed metadata compressed in accordance with updated metadata in a first memory for storing normal data and master metadata representing a relation between a logical address and a physical address for accessing the normal data.

Storing of the compressed metadata may include: generating bitmap data representing a difference between the master metadata and the updated metadata; and compressing the bitmap data and storing the compressed bitmap data in the first memory. At this time, the bitmap data may be generated by performing exclusive-OR on the master metadata and the updated metadata.

The control method may further include reconstructing the updated metadata by using the compressed metadata and the master metadata.

In this case, reconstructing of the updated metadata may include: reconstructing bitmap data from the compressed metadata; and reconstructing the updated metadata from a difference between the bitmap data and the master metadata. Also, the control method may further include loading the reconstructed updated metadata into a cache memory.

The control method may include reconstructing the updated metadata by performing exclusive-OR on the master metadata and bitmap data.

### Advantageous Effects

A semiconductor memory system and a control method for the same, according to the present invention have an advantage in that they can improve the performance of a flash memory device by compressing metadata intended to be updated and reducing a storage area of metadata and can also improve the endurance of the flash memory device by preventing a large amount of unnecessary data from being written to the flash memory device.

### BRIEF DESCRIPTION OF THE DRAWINGS

In order to more fully understand the drawings referred to in the detailed description of the present invention, a brief description of each drawing is provided.

FIG. 1 is a block diagram showing the configuration of a semiconductor memory system according to a first embodiment of the present invention.

FIG. 2 is a flowchart showing a method for controlling metadata in the semiconductor memory system as shown in FIG. 1.

FIG. 3 is a flowchart showing an embodiment of a method for compressing metadata as shown in FIG. 2.

FIG. 4 is a flowchart showing an embodiment of a method for reconstructing metadata as shown in FIG. 2.

### MODE FOR CARRYING OUT THE INVENTION

To fully understand the present invention, the advantages in the operation of the present invention, and the objects accomplished by the implementations of the present invention, reference should be made to the accompanying drawings illustrating exemplary embodiments of the present invention and the contents described in the accompanying drawings.

Hereinafter, exemplary embodiments of the present invention will be described in detail with reference to the accompanying drawings. The same elements will be designated by the same reference numerals although they are shown in different drawings.

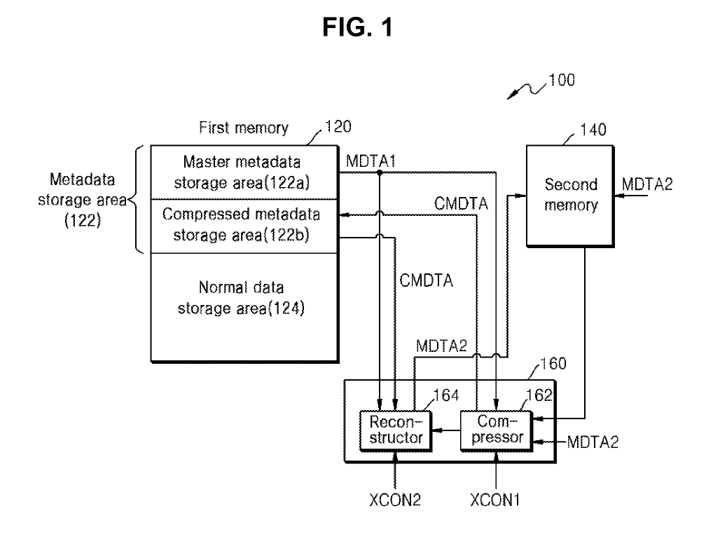

FIG. 1 is a block diagram showing the configuration of a semiconductor memory system according to a first embodiment of the present invention.

Referring to FIG. 1, a semiconductor memory system 100 according to a first embodiment of the present invention includes a first memory 120, a second memory 140, and a control logic 160.

The first memory 120 is accessed when data is intended to be programmed into it or data is intended to be read from it. In order to access the first memory 120, a logical address of the first memory 120 must be converted into an actual physical address in the first memory 120.

A relation between a logical address and a physical address in the first memory may be represented by metadata. Metadata may be stored in the first memory, as will be described below. Accordingly, a first memory 120 may include a normal data storage area 124 for storing normal data programmed by a user, and a metadata storage area 122 for storing metadata representing a relation between a logical address and a physical address in the first memory 120. The normal data storage area 124 is actually larger than the metadata storage area 122. However, for convenience of description, as shown in FIG. 1, the metadata storage area 122 has the same size as that of the normal data storage area 124.

The metadata storage area 122 for storing metadata also includes a master metadata storage area 122a for storing master metadata MDTA1 and a compressed metadata storage area 122b for storing compressed metadata CMDTA. The details of metadata will be described below.

The first memory 120 may be a flash memory. In this case, the conversion of a logical address into a physical address may be performed by a flash translation layer (not shown). The flash translation layer may be included in the control logic 160 as described below, or a memory controller which may include all or some of the control logic 160 as described below, or the like.

When there occur an operation of programming data into the first memory 120, an operation of erasing data therefrom and the like, an update of metadata may be requested by the flash translation layer. Metadata obtained by updating currently-used metadata is referred to as “updated metadata MDTA2.”

As described above, the metadata represents the relation between a logical address and a physical address in the first memory. Accordingly, in order to secure the reliability of the semiconductor memory system, the matching of metadata must be ensured. Therefore, when an update of metadata occurs, the updated contents must be stored in the first memory 120. At this time, it can be known that a request for updating metadata frequently occurs whereas the amount of the updated data is smaller than that of the entire metadata.

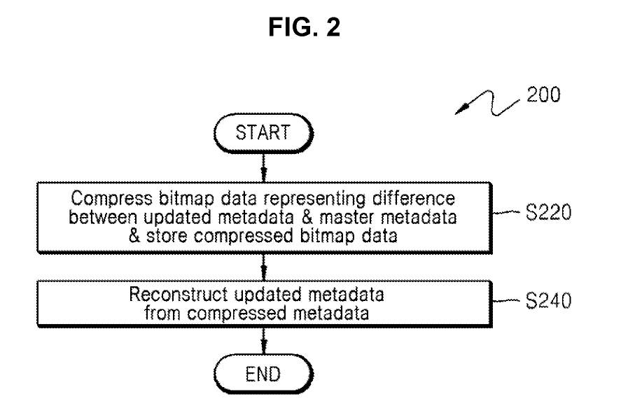

Continuously, referring to FIG. 1, when an update of metadata, namely, updated metadata MDTA2 is requested, as shown in FIG. 2 illustrating a method 200 for controlling metadata in the semiconductor memory system as shown in FIG. 1, a compressor 162 of the control logic 160 generates compressed metadata CMDTA in response to a first control signal XCON1 (S220). The first control signal XCON1 may be generated by a request from the flash translation layer. Namely, by a request from the flash translation layer, an operation of storing the compressed metadata CMDTA in the first memory 120 may be performed.

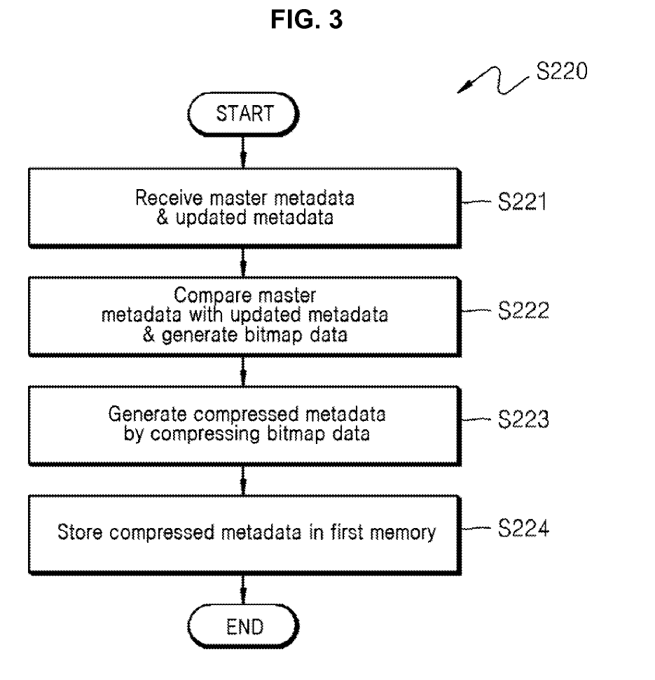

As shown in FIG. 3 which more specifically illustrates the operation of the compressor 162, the compressor 162 first receives updated metadata MDTA2 and master metadata MDTA1 (S221). At this time, the updated metadata MDTA2 may be received from the second memory 140. The second memory 140 which is a RAM in the form of a cache memory to which fast access may be gained, may be a SRAM (Static Random Access Memory) or a DRAM (Dynamic Random Access Memory). Namely, for fast access, the flash translation layer may access metadata loaded into the second memory.

Then, the compressor 162 compares the updated metadata MDTA2 with the master metadata MDTA1, and generates bitmap data representing a difference between the updated metadata MDTA2 and the master metadata MDTA1 (S222). The compressor 162 may generate the bitmap data by performing exclusive-OR on the updated metadata MDTA2 and the master metadata MDTA1.

Then, the compressor 162 generates compressed metadata CMDTA by compressing the bitmap data (S223). Next, the compressed metadata CMDTA is stored in the first memory 120.

For convenience of description, the compressed bitmap data is referred to as “compressed metadata CMDTA.” As described above, the compressed metadata CMDTA may be stored in the compressed metadata storage area 122b of the first memory 120 (S224).

The first control signal XCON1 may be a signal for requesting an update of the master metadata MDTA1. The first control signal XCON1 may be generated by the flash translation layer. However, the present invention is not limited to this configuration. The first control signal XCON1 may be generated by the control logic 160, or the memory controller (not shown) which may include all or some of the control logic 160, or the like.

As described above, the semiconductor memory system and the method for controlling metadata in the semiconductor memory system, according to an exemplary embodiment of the present invention compresses only bitmap data representing a difference between updated metadata and the existing master metadata, and stores the compressed bitmap data. Accordingly, they can reduce storage space in a memory, and can also prevent performance degradation of the memory.

Referring back to FIG. 1 and FIG. 2, a reconstructor 164 of the semiconductor memory system according to an exemplary embodiment of the present invention reconstructs updated metadata MDTA2 from compressed metadata CMDTA in response to a second control signal XCON2, and loads the updated metadata MDTA2 into the second memory 140 (S240). As described above, the second memory 140 which is a RAM in the form of a cache memory to which fast access may be gained, may be a SRAM or a DRAM. For fast access, the flash translation layer accesses the metadata loaded into the second memory.

Also, the second control signal XCON2 may be generated by the flash translation layer. Otherwise, after the completion of the compression operation, the second control signal XCON2 may be transmitted by the compressor 162.

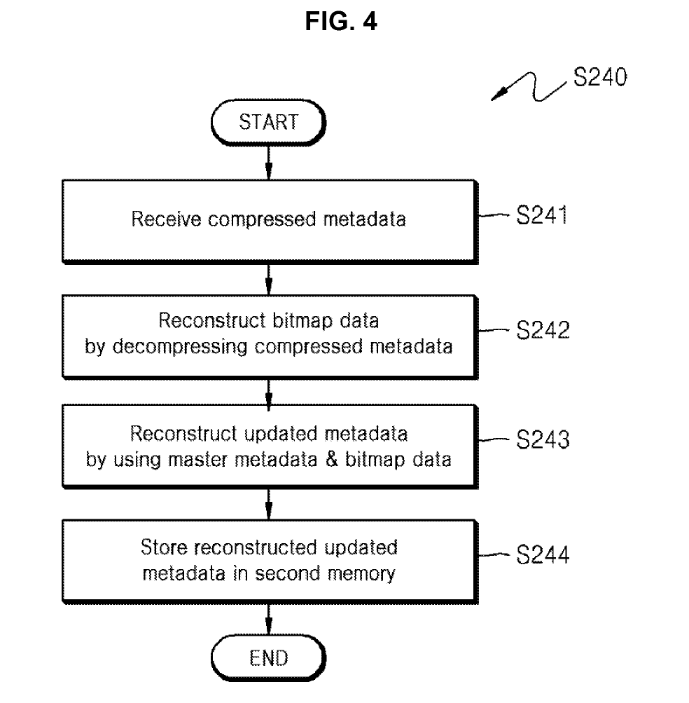

A more detailed operation of reconstructing updated metadata MDTA2 from compressed metadata CMDTA is shown in FIG. 4. Referring to FIG. 1 and FIG. 4, the reconstructor 164 receives compressed metadata CMDTA (S241), and reconstructs bitmap data by decompressing the compressed metadata CMDTA (S242). The reconstructor 164 reconstructs updated metadata MDTA2 by performing exclusive-OR on the reconstructed bitmap data and master metadata MDTA1 (S243). The reconstructor 164 loads the updated metadata MDTA2 as reconstructed above into the second memory 140 to which fast access is gained (S244).

When a request for a new update occurs after the update as described above, the update operation as described above may be repeated. Namely, the operation of repeatedly updating metadata may be performed by compressing bitmap data representing a difference between metadata intended to be updated and master metadata and storing the compressed bitmap data in the first memory, and by reconstructing the bitmap data and loading the reconstructed bitmap data into the second memory.

As described above, the semiconductor memory system according to an exemplary embodiment of the present invention compresses a difference between metadata intended to be updated and the existing metadata and stores the compressed difference, and reconstructs bitmap data from the compressed metadata and updates the existing metadata. Therefore, the semiconductor memory system may be managed in such a manner as to be optimized for the update characteristics of metadata such that an update request frequently occurs whereas the amount of the updated data is relatively small.

Namely, the semiconductor memory system according to an exemplary embodiment of the present invention can improve the endurance of the flash memory device by preventing a large amount of unnecessary data from being written to the flash memory device.

As described above, exemplary embodiments have been disclosed in this specification and the accompanying drawings. Although specific terms are used herein, they are just used for describing the present invention, but do not limit the meanings and the scope of the present invention disclosed in the claims. For example, the control logic 160 as shown in FIG. 1 may be included in a micro-controller, or may be installed in a separate compression/reconstruction engine.

Accordingly, a person having ordinary knowledge in the technical field of the present invention will appreciate that various modifications and other equivalent embodiments can be derived from the exemplary embodiments of the present invention. Therefore, the scope of true technical protection of the present invention should be defined by the technical idea of the appended claims.

1. A semiconductor memory system comprising:
a first memory for storing normal data and master metadata representing a relation between a logical address and a physical address for accessing the normal data; and
a control logic for generating compressed metadata compressed in accordance with updated metadata in response to a first control signal and storing the compressed metadata in the first memory.

2. The semiconductor memory system as claimed in claim 1, wherein the compressed metadata is generated by compressing bitmap data representing a difference between the updated metadata and the master metadata.

3. The semiconductor memory system as claimed in claim 2, wherein the bitmap data is generated by performing exclusive-OR on the master metadata and the updated metadata.

4. The semiconductor memory system as claimed in claim 1, wherein the control logic comprises a compressor for generating the compressed metadata.

5. The semiconductor memory system as claimed in claim 1, wherein the control logic further comprises a reconstructor for reconstructing the compressed metadata.

6. The semiconductor memory system as claimed in claim 5, wherein the reconstructor reconstructs the updated metadata by decompressing the compressed metadata, reconstructing bitmap data, and comparing the bitmap data with the master metadata.

7. The semiconductor memory system as claimed in claim 6, wherein the reconstructor reconstructs the updated metadata by performing exclusive-OR on the master metadata and the bitmap data.

8. The semiconductor memory system as claimed in claim 6, wherein the reconstructed updated metadata is loaded into a second memory.

9. The semiconductor memory system as claimed in claim 8, wherein the second memory corresponds to a cache memory.

10. The semiconductor memory system as claimed in claim 1, wherein the first memory is a flash memory.

11. A control method in a semiconductor memory system, the method comprising:
storing compressed metadata compressed in accordance with updated metadata in a first memory for storing normal data and master metadata representing a relation between a logical address and a physical address for accessing the normal data.

12. The control method as claimed in claim 11, wherein storing of the compressed metadata comprises:
generating bitmap data representing a difference between the master metadata and the updated metadata; and
compressing the bitmap data into a compressed bitmap data and storing the compressed bitmap data in the first memory.

13. The control method as claimed in claim 12, wherein the bitmap data is generated by performing exclusive-OR on the master metadata and the updated metadata.

14. The control method as claimed in claim 11, further comprising reconstructing the updated metadata by using the compressed metadata and the master metadata.

15. The control method as claimed in claim 14, wherein reconstructing of the updated metadata comprises:
reconstructing bitmap data from the compressed metadata; and
reconstructing the updated metadata from a difference between the bitmap data and the master metadata.

16. The control method as claimed in claim 14, further comprising loading the reconstructed updated metadata into a cache memory.

17. The control method as claimed in claim 16, wherein the control method comprises reconstructing the updated metadata by performing exclusive-OR on the master metadata and bitmap data.
